(19) United States
(12) Patent Application Publication
(10) Pub. No.: US 2004/0222071 A1
(43) Pub. Date: Nov. 11, 2004

(54) Troughing conveyor idler

(76) Inventor: James Dennis Pomfret, Stanmore NSW (AU)

Correspondence Address: COHEN, PONTANI, LIEBERMAN & PAVANE, 551 FIFTH AVENUE, SUITE 1210, NEW YORK, NY, 10176, US

(21) Appl. No.: 10/434,813

(22) Filed: May 9, 2003

(51) Int. Cl. B65G 39/10

(52) U.S. Cl. 198/830

(57) ABSTRACT

An idler station for a conveyor comprising a frame aligned transverse to the direction of travel of the conveyor wherein there are troughing idlers arranged in a substantially U-shaped configuration with all idlers being of like dimensions; the centre, substantially horizontal and lowest idler position being occupied by two parallel idlers mounted on a cradle having a central pivot such that each centre idler on the pivot is offset, one forward and one behind with respect to adjacent wing idlers when viewed from above.

The present invention relates to a Troughing Idler System for a belt type conveyor and in particular to a system involving use of a dual centre idler; the dual centre idlers being mounted on a common cradle.

For many years load carrying conveyors have been supported on free wheeling idlers typically arranged in a U-shape configuration and mounted on transverse frames in turn spaced from and located with respect to each other by stringers.

Typically idler configurations involve two inclined “wing” idlers either side of a centre idler at the base of the U. This is typically the configuration favoured for the load carrying portion of the belt whereas a simpler V configuration twin return idler setup may be utilised for the return path of the belt when it is not subjected to a load.

Typically the wing idlers do not carry as much load as the centre idlers at the base of the U as the centre idler typically carries 70% of the vertical load with each outside wing idler carrying only 15% of the load. Recognising this to be the case installations often provide the centre position with a larger idler with correspondingly larger bearings, shafts, journals etc. as compared with the wing idlers. Construction and maintenance of a conveyor system having many hundreds if not thousands of idlers utilising two different sizes of idlers is however far more difficult than if a single size of idler is utilised. For example larger stocks of spare idlers must be carried where there are two different configurations of idler. The weight and bulk of the very large number of large centre idlers required also increases the difficulty and cost of construction of a conveyor systems such as underground conveyor systems where all components must be carried in and out. Of course the wing idlers may be constructed to the same standard as the centre idlers in order to alleviate the difficulty associated with two different types of spares although this results in even more bulk with the attendant detrimental effects as aforementioned particularly where a conveyor has been set up underground.

Offset idlers which typically utilise five idlers per set as opposed to the more conventional three idler per set configuration above described have been utilised wherein alternate idlers are arranged in a staggered pattern when viewed from above. Although the resulting shorter idlers may be made to conform more closely to the U-shaped configuration of a conveyor belt the load is still the greatest at the centre idler position and furthermore there are inherent problems in matching belts to the profile of the staggered idlers in such arrangement.

It is accordingly an object of the present invention to emolliate one or more of the abovementioned difficulties with existing troughing idler configurations or at least to provide the market with an alternative.

According to the present invention there is provided a conveyor having an idler station mounted on a frame aligned transverse to the direction of travel of a conveyor wherein there are troughing idlers arranged in a substantially U-shaped configuration with all idlers being of like dimensions; the centre, substantially horizontal and lowest idler position being occupied by two parallel idlers mounted on a cradle having a central pivot such that each centre idler on the pivot is offset, one forward and one behind with respect to adjacent wing idlers when viewed from above.

One embodiment of the present invention will now be described with reference to the accompanying drawings in which

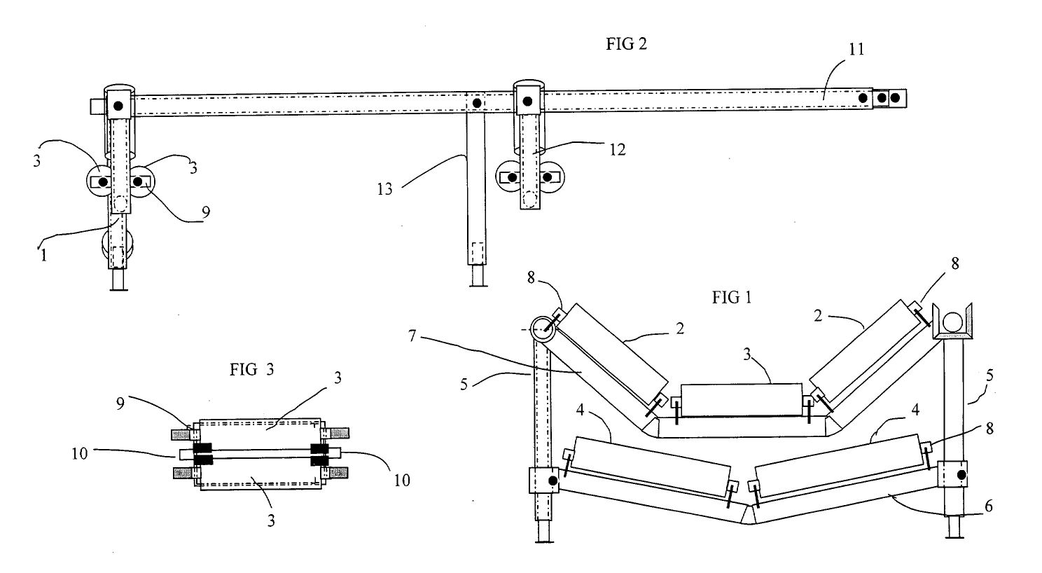

FIG. 1 is a front elevation of an idler station in accordance with the present invention;

FIG. 2 is a side elevation of two idler stations and associated stringers and frames in accordance with the present invention and

FIG. 3 is a top plan view of a centre idler pair and associated cradle in accordance with the present invention.

According to the embodiment of FIG. 1 there is disclosed a frame 1 adapted to lie transversely with respect to the direction of belt travel and to support wing idlers 2 and centre idlers 3 as well as return idlers 4.

It will be appreciated that the frame comprises upstanding legs 5 as well as a V-shaped lower support 6 and a substantially U-shaped upper support 7. The support arms provide anchorage for spindles 8 about which the idlers rotate. The support arms must also be capable of transferring the weight of the load on a belt (not shown) from idlers 2 and 3 to legs 5.

With reference now to FIG. 2 it will be seen that there are two centre idlers 3 mounted parallel to each other upon cradle 9 which cradle is in turn is supported for limited rotational movement about a pivot 10 (best viewed in FIG. 3).

The presence of cradle 9 and pivot 10 ensures that each of idlers 3 mounted to the cradle 9 will be equally loaded. If for example the heaviest portion of a load on the belt (not shown) at a particular instant is present above idlers 3 but to the right of frame 1a then (with reference to FIG. 2) the centre idler on the right hand side of frame 1a would be more heavily loaded than that the idler on the left if it were not for the existence of pivot ten. The existence of pivot 10 enables the cradle 9 to position that idler 3 to the right of frame 1a slightly lower than the complimentary centre idler 3 to the left of the frame so as to assist in equalising the load.

It will therefore be appreciated that the centre idler pair can be designed so that only 50% of the load which would normally be placed on the centre idler is borne by each of the pair of centre idlers 3. Given that centre idlers bear up to 70% of the load of a conveyor belt then each of the dual centre idlers need only be designed to accommodate 35% of the total load. The provision of wing idlers identical to the centre idlers therefore does not result in such a massive over engineering of wing idlers with attendant undesirable weight as would be the case with a conventional single centre idler. A common spare parts supply may therefore be utilised for both wing and centre idlers as well as associated bearings, spindles, etc.

It has also been found desirable to journal the pivot pin 10 for cradle 9 (best viewed in FIG. 3) in a resiliently deformable bush of say rubber. In this manner it has been found that wear can be reduced having regard to the fact that such bush will absorb vibration and may also be set up so that the cradle adopts a horizontal equilibrium position. If for example pivot pins 10 were to be journaled in a simple ball or roller bearing then a horizontal equilibrium position would not necessarily be maintained. It has been found that such rubber bush about pivot pins 10, or other like resilient elastomeric sleeves, allow a certain amount of torsional movement required to provide idler alignment with the belt whilst at the same time damping vibrations and oscillations that can be produced by the action of load travelling over the idlers. The resilient mount is substantially wear free and maintenance free.

Cradles 9 are also designed to permit the shafts of the idlers 3 mounted thereupon to be extended in order to provide a place for a removal tool to be slid over the exposed shaft thereby assisting complete removal and replacement of the shaft and idler. This arrangement contrasts with an in-line prior art idler arrangement where only a short shaft may be fitted into the frame without any risk of the shaft end interfering with those of adjacent idlers.

It will be appreciated that the dual centre idler technology of the present invention may be exploited in two ways. Firstly smaller idlers may be utilised than the conventional systems involving similar spacing of idler stations. Alternatively if dual centre idlers are utilised which have similar dimensions and hence capacities greater than prior art arrangements utilising single centre idlers the spacing between idler stations may be increased.

As abovementioned it is highly desirable to minimise the mass associated with idlers and idler stations but even more importantly it is desirable to decrease the overall mass of the entire belt support structure including idler stations, transverse supporting frames and stringers 11 which are typically provided between transverse frames. Typically the stringers provided between adjacent transverse frames are of substantial construction as they are not only intended to provide a convenient method of setting out and constructing a conveyor to a regular dimensional pattern having equally spaced transverse frames but they are also utilised in order to suspend idler stations therefrom.

Typically idler stations are arranged transversely of the stringers in two places intermediate adjacent transverse frames defining the end points of each stringer. These idler sets are arranged at the 25% and 75% positions along the stringer length. This positioning is dictated by the necessity to minimise the number of transverse frames whilst placing the idler stations (through which the weight of the conveyor payload is transmitted via the stringers to the frames) in reasonably close proximity to the frames rather than at the mid-point of the stringers.

The stringers are therefore subject to a vertical bending moment and are designed accordingly with significant weight and bulk penalties. The transverse frame functions are to maintain the relative locations of the stringers and to transfer the vertical loads from the stringers into the ground. With the ability of the double centre idler arrangement of the present invention to allow more load to be carried by each idler set utilising idlers of the same unit mass as conventional idler sets it is possible not only to increase idler spacing but also to incorporate the idler sets into a significantly reduced number of transverse frames thus eliminating the load bearing function of the stringer.

The main function of the stringers then becomes one of convenience for conveyor construction and it would theoretically be possible to eliminate the stringers altogether. Certainly the stringers would then have no direct load bearing function. With reference now to FIG. 2 there is depicted two adjacent idler sets in accordance with the present invention the first of which is located substantially at a cross frame whereas the second 12 is located slightly to the right of transverse frame 13. It is not essential that the idler stations be located exactly at the cross frame position although in order to exploit the decrease in weight which is now possible in relation to stringers 11 it is highly desirable that idler station in accordance with the present invention be located as close as possible to transverse frames.

It will be appreciated that an idler system in accordance with the present invention therefore permits a reduction in the number of transverse frames if the idler stations are located at or near such frames and furthermore a drastic weight reduction or even elimination of stringers intermediate adjacent cross frames.

It should be appreciated that alternate embodiments of the present invention apart from that above described may be devised without the particular scope and intendment thereof.

The claims defining the invention are as follows:

1 An idler station for a conveyor comprising a frame adapted to be aligned transverse to the direction of travel of the conveyor; troughing idlers arranged on the frame in a substantially U-shaped configuration; the centre lowest idler position being occupied by two parallel idlers mounted on a cradle having a central pivot.

2 An idler station in accordance with claim 1 wherein all idlers are of like dimensions.

3 An idler station in accordance with claim 1 wherein each centre idler on the pivot is offset, one forward and one behind, with respect to adjacent wing idlers either side thereof when viewed from above.

4 An idler station in accordance with claim 1 wherein the cradle and central pivot are designed so that approximately 50 percent of the load which would normally be borne by the centre idler position is borne by each of the pair of centre idlers

5 An idler station in accordance with claim 1 wherein the central pivot for the cradle is journalled in a resiliently deformable bush which biases the cradle to an equilibrium position whereat each of the idlers on the cradle are maintained at substantially the same height.

6 An idler station in accordance with claim 1 wherein the central pivot for the cradle is journalled in a resiliently deformable bush adapted to absorb vibration.

7 An idler station in accordance with claim 1 wherein are the central pivot for the cradle is journalled in a resiliently deformable bush manufactured from rubber or other like thermoplastic material.

8 An idler station in accordance with claim 1 wherein the placement of idlers on the frame and cradle is such that shafts upon which the idlers are mounted may be extended axially without interference with adjacent idlers or shafts to facilitate placement of a removal tool about the exposed shafts and hence complete removal and replacement of the shaft and idler.

9 An idler station in accordance with claim 1 hereof in combination with a conveyor framing system having transverse frames located by intermediate stringers; the idler station being mounted at the cross frame position or on the stringer but at a position no more than 15 percent removed along the length of stringer from the cross frame position.
